(19) United States
(12) Patent Application Publication
(10) Pub. No.: US 2006/0164977 A1
(43) Pub. Date: Jul. 27, 2006

(54) Provision of network elements in a communication system

(76) Inventor: Klaus Kienzle, Sauerlach (DE)

Correspondence Address: Siemens Corporation;Intellectual Property Department, 170 Wood Avenue South, Iselin, NJ, 08830, US

(21) Appl. No.: 10/522,474

(22) PCT Filed: Jul. 25, 2003
(86) PCT No.: PCT/DE03/02524

§ 371 Date: Aug. 22, 2005

(30) Foreign Application Priority Data
Jul. 26, 2002 (DE) 10234168.0

(51) Int. Cl. H04J 1/16; H04L 12/28; H04L 12/26; H04L 1/00

(52) U.S. Cl. 370/229; 370/252; 370/254

(57) ABSTRACT

According to the invention, at least partly loaded network elements are determined for the provision of network elements in a communication system by means of providing a service. Load thresholds are also determined for network elements. On a service provision request an exceeding of the fixed load threshold values, related to the provision of the requested service, is checked for. On exceeding the threshold values a provision of the required network elements is authorised.

### CROSS REFERENCE TO RELATED APPLICATIONS

This application is the US National Stage of International Application No. PCT/DE03/02524, filed Jul. 25, 2003 and claims the benefit thereof. The International Application claims the benefits of German application No. 10234168.0 DE filed Jul. 26, 2002, both of the applications are incorporated by reference herein in their entirety.

### FIELD OF INVENTION

The present invention relates to a method for providing network elements in a communication system, to a communication network control and monitoring system and to a control program for a communication connection management device.

### BACKGROUND OF INVENTION

On the telecommunications market, numerous services, in particular Internet services, are provided for customers by network operators. Services provided by network operators are subdivided into different quality-of-service levels in order to fulfill customer needs for guaranteed levels of service quality and in order to differentiate a network operator from its competitors. For example, services are provided at low cost for private customers and services which are more extensive in scope are provided at higher cost for business customers. The extended scope of services consists, for example, in ensuring a high level of availability and a low level of data loss. To this end, service level agreements (SLAs) are concluded between network operator and customer in which the scope and quality of services to be provided for the customer are stipulated. Particular importance is attached here to demonstrating compliance with the service level agreement to the customer. For proof of this kind, services have to be monitored in order, for example, to record failures and to determine the availability of a service. In addition, measurements are performed in order to record service quality parameters such as data loss. The provision of services is therefore not restricted purely to administering service parameters such as bandwidth or call number but service-specific additional functions are also controlled.

In order to provide services in a communication system on time for customers, it must be ensured that network elements relevant to the provision of a service are available. Unnecessarily many network elements should not, however, be made available as substantial costs may be associated with operating, servicing and maintaining these network elements.

### SUMMARY OF INVENTION

The object of the present invention is to establish a method for the provision of network elements in a communication system, said method being optimized from the viewpoint of efficiency and network operations, and to indicate a suitable implementation of the method and a suitable communication network control and monitoring system for performance of the method.

This object is achieved according to the invention in a method, a communication network control and monitoring system, and a control program for a communication connection management device having the features specified in the claims.

A key aspect of the present invention is that at least partially loaded network elements are determined by means of providing a service and that load thresholds are stipulated for network elements. This enables record to be kept of network elements or resources loaded as a result of services already provided and an assessment to be made of a respective degree of loading by means of loading thresholds. On a service provision request, an exceeding of the stipulated load threshold values in connection with provision of the requested service is checked and, where applicable, a provision of required network elements is initiated. The procedure described offers the advantage of an improved loading of available network elements by virtue of the fact that additionally required network elements or resources are requested on demand. In addition, a requesting of network elements in compliance with demand prevents unused network elements from being provided or installed over longer periods, which in turn brings about a reduction in the costs connected with a provision or installation. With regard to network monitoring, the advantage also emerges that only actually loaded network elements or resources have to be monitored, which enables further cost savings as a result of monitoring tasks no longer being applicable.

### BRIEF DESCRIPTION OF THE DRAWINGS

An exemplary embodiment of the present invention will be described in detail below with reference to the drawings, in which

FIG. 1 shows a schematic representation of a communication network control and monitoring system, and

FIG. 2 shows a diagram for illustrating a provision of network elements required for a service in a broadband network which is connected to a transport network.

### DETAILED DESCRIPTION OF INVENTION

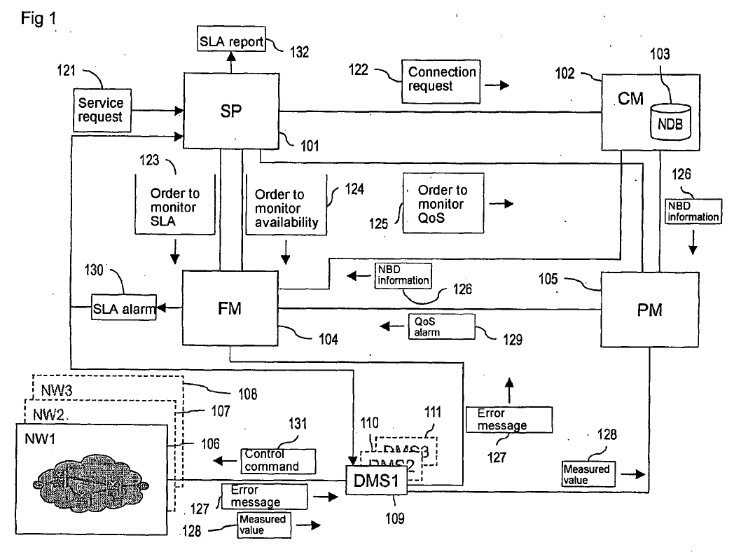

The communication network control and monitoring system represented schematically in FIG. 1 comprises a service providing device 101, a communication connection management device 102, an error monitoring device 104 and a service quality monitoring device 105. The service providing device 101 is provided for establishing or modifying services. Here, the service providing device 101 receives messages 121 containing service requests and converts these into messages 122 containing connection requests which are transmitted to the communication connection management device 102.

The communication connection management device 102 is provided for storing information which describes the functional properties and topological arrangement of network elements relevant to provision of a service. This information is assigned to the respective service and stored in a network element database 103 assigned to the communication connection management device 102. The network elements relevant to provision of a service include, for example, network access points, terminal connections and line connections along an end-to-end network path between two service access points. Functional properties of network elements are for example bandwidth, communication protocols supported and switching technologies used. The description of the topological arrangement of network elements comprises a subdivision of the network elements into nodal network elements, such as measuring points and switching points, and edge network elements, such as line connections, and a processing as topological information in accordance with a node-edge model. The information stored in the network element database 103 is made requestably available to the error monitoring device 104 and the service quality monitoring device 105.

Upon the establishment or modification of a service, a message 123 is transmitted from the service providing device 101 to the error monitoring device 104 with an order to monitor the availability of network elements which are specified as relevant to provision of the respective service. Correspondingly, a message 125 is transmitted to the service quality monitoring device 105 with an order to monitor the quality of the service. By means of these monitoring orders, the error monitoring device 104 and the service quality monitoring device 105 are prompted to compare error messages 127 and measured values 128 recorded in subnetworks 106, 107, 108, said error messages and measured values being forwarded to the error monitoring device 104 or the service quality monitoring device 105 via a network operating system 109, 110, 111 assigned to the respective subnetwork, with the information stored in the network element database 103 for inadmissible deviations. To this end, corresponding network element database information is requested by the error monitoring device 104 or the service quality monitoring device 105 and transmitted as messages 126 to said devices. Where there is an inadmissible deviation from the information stored in the network element database 103, a message 129, 130 about a reduction in service capacity is generated by the error monitoring device 104 or service quality monitoring device 105, giving details of the service concerned.

The monitoring of availability and of service quality is carried out in accordance with a service level agreement concluded between a customer and a network operator. Therefore, only information relating to the network elements specified by a service level agreement as relevant to provision of a service is stored in the network element database 103. Furthermore, error messages or measured values are recorded only in relation to the network elements specified by the service level agreement as relevant to provision of the service. To monitor the provisions stipulated under a service level agreement, upon establishment or modification of a service a message 123 is transmitted from the service providing device 101 to the error monitoring device 104 with an order to monitor a service level agreement. This means that a recording of error messages or measured values relating to network elements specified by the service level agreement as relevant to provision of a service is initiated as soon as the service concerned is established or modified.

If the evaluation of a measured value 128 in the service quality monitoring device 105 indicates that a network element is being operated outside an admissible operating range, then an alarm message 129 is transmitted from the service quality monitoring device 105 to the error monitoring device 104 about a violation of a service quality criterion and converted there into an alarm message 130 about a violation of a service level agreement. An error message 127 is converted in the error monitoring device 104 directly into an alarm message about the violation of a service level agreement. The alarm message 130 contains a statement about the availability of the service or the quality of the service and is transmitted for the purposes of rectifying the reduction in service capacity to a network operating system 109,110,111 which is assigned to the subnetwork 106,107,108 in which an error or a violation of the service quality criterion occurs. The alarm message 130 is converted by the respective network operating system 109,110,111 into a control command 131 which is transmitted as a message for rectifying the reduction in service capacity to a selected control device, not explicitly shown, in the respective subnetwork 106,107,108. To rectify the reduction in service capacity, a reconfiguration of the network element affected by rectification of the reduction in service capacity is carried out, the respective network control system 109,110,111 accessing the information stored in the network element database 103. This also applies to configuration of a network element upon establishment, modification or deletion of a service.

The alarm message 130 about a violation of a service level agreement is likewise transmitted to the service providing device 101. There, it is updated with customer data and converted into a report 132 about compliance with or violation of a service level agreement.

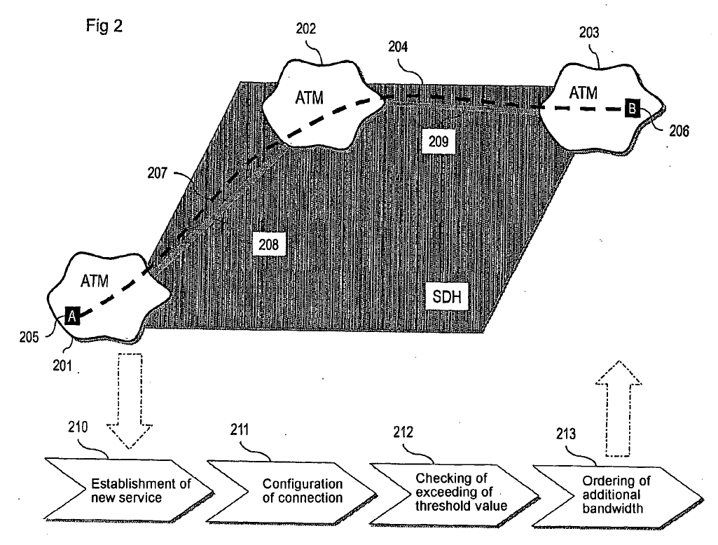

A provision of network elements required for a service in a broadband network which is connected to a transport network is illustrated by FIG. 2. The broadband network comprises three ATM (asynchronous transfer mode) subnetworks 201,202,203 which are connected to one another via a first line connection 208 and a second line connection 209 of an SDH (synchronous digital hierarchy) transport network 204. A scenario is discussed below according to which between a first service access point 205 and a second service access point 206 a connection 207 is requested and is to be established as a new service (step 210). To this end, the connection 207 is first configured by means of the communication connection management device 102 accessing information stored in the network element database 103 (step 211). A precondition for this is that at least partially loaded network elements be determined by services already provided and that load thresholds be stipulated for network elements.

Load values of network elements, said load values being connected with a provision of a service, are preferably stored in the network element database 103. The network elements loaded by a provision of services can then be determined with reference to these load values. This offers the advantage that costly network calculations or planning can be dispensed with, which in turn leads to cost savings. Advantageously, the load threshold values stipulated are also stored in the network element database 103. The advantage here is that bottlenecks in available network elements can be detected automatically by the communication connection management device 102 and fewer performance measurements have to be carried out and evaluated in the service quality monitoring device 105. After configuration 211 of the connection 207, a check 212 is carried out as to whether an exceeding of stipulated load threshold values is connected with a provision of the requested service. The check 212 can be carried out either by accessing the load values stored in the network element database 103 and comparing these with the load threshold values or by comparing load values determined as part of performance measurements with the load threshold values. In this way, it can be checked whether, for example, the bandwidth still available on the two SDH line connections 208,209 is still sufficient.

In the case of a possible exceeding of threshold values, an order 213 is made for additional bandwidth, for example in the form of a further SDH line connection. In general, a provision of required network elements can be initiated by a work instruction to a network planning system, not shown in detail, or to a network operating system 109,110,111. Alternatively, a provision can also be initiated by means of an automatic installation of the respectively required network elements initiated by the communication connection management device 102.

Implementation of the process steps performed in the service providing device 101, the communication connection management device 102, the error monitoring device 104 and the service quality monitoring device 105 is carried out respectively by means of a control program provided for the service providing device 101, the communication connection management device 102, the error monitoring device 104 and the service quality monitoring device 105. Here, the respective control program runs on a data processing system assigned to the service providing device 101, the communication connection management device 102, the error monitoring device 104 or the service quality monitoring device 105. In particular, the steps of the described method for providing network elements are preferably executed by means of a control program for the communication connection management device 102. Depending on the application case, use of a shared data processing system on which the specified control programs run either separately or as combined control programs is also possible.

The application of the present invention is not restricted to the exemplary embodiment described here.

1-10. (canceled)

11. A method for providing a network element in a communication system, comprising:
determining if the network element is at least partially loaded with respect to a provided service;
stipulating a maximum load threshold value for the network element;
checking if a service provision request exceeds the stipulated value; and
initiating a network element provisioning when the check indicates that the stipulated value is exceeding.

12. The method according to claim 11, wherein the step of stipulating the threshold occurs prior to the determining step.

13. The method according to claim 11, wherein a functional property information and a topological arrangement information of a network element with respect to a provision of service are stored in a network element database.

14. The method according to claim 13, wherein the functional property information and the topological are assigned to the service.

15. The method according to claim 14, wherein a provision of service load value for the network element is stored in the network element.

16. The method according to claim 15, wherein the provision of service load value determines the network element load.

17. The method according to claim 14, wherein the load threshold value is stored in the network element database.

18. The method according to claim 14, wherein a service level agreement information relevant to a provision of service is stored in the network element database.

19. The method according to claim 11, wherein a performance measurement value exceeding the stipulated value determines the loading of the network element.

20. The method according to claim 11, wherein the network elements provisioning is initiated by a work instruction to a network order selected from the group consisting of network planning, network operating system and combinations thereof.

21. The method according to claim 11, wherein the network element provisioning initiated by an automatic installation of the respective network element.

22. A communication network control and monitoring system, comprising:
a communication connection management device, comprising:
a network element operating at an at least partial capacity determined with respect to a provision of service,
a maximum capacity threshold stipulated for the network element,
a service provision request that triggers a comparison of the stipulated threshold with the service provision request, an exceeding of the service provision request over the stipulated threshold initiating a provision of the network element;
a network element database for storing information describing a functional property and a topological arrangement of the network element relevant to the provision of service and for assigning the functional property and topological arrangement information to the respective service; and
a monitoring device selected from the group consisting of service quality monitoring device, error monitoring device, and combinations thereof for comparing recorded measured values with the information stored in the network element database for a deviations and for generating a message about a service capacity reduction, thereby providing details of the service concerned in the case of the deviation.

23. A control program for a communication connection management device of a communication network control and monitoring system, the control program adapted for loading into a working memory of a data processing system assigned to the communication management device, comprising:
a first code section for determining if the network element is at least partially at capacity with respect to a provision of service;
a second code section for stipulating a maximum load threshold value for the network element;
a third code section for checking if a service provision request exceeds the stipulated value; and
a fourth code section for initiating a network element provisioning when the check indicates that the stipulated value is exceeding.

24. A control program according to claim 23, wherein a code section is selected from the group consisting of first code section, second code section, third code section, forth code section, and combinations thereof.
